(19) United States
(12) Patent Application Publication
(10) Pub. No.: US 2005/0076296 A1
(43) Pub. Date: Apr. 7, 2005

(54) System and method for converting contents for personal digital assistants

(76) Inventors: Young Sik Lee, Kwanak-Gu (KR); Jong Cheon Park, Burlington, MA (US)

Correspondence Address: HOVEY WILLIAMS LLP, Suite 400, 2405 Grand, Kansas City, MO, 64108, US

(21) Appl. No.: 10/371,688

(22) Filed: Feb. 20, 2003

(30) Foreign Application Priority Data
May 9, 2002 (KR) 2002-25620

(51) Int. Cl. G06F 17/00

(52) U.S. Cl. 715/523; 715/530

(57) ABSTRACT

Disclosed herein is system and method for converting contents for personal digital assistants, which can conveniently convert contents provided on File Explorer, application, and Internet Explorer, such as word files and image files as well as Web documents, into contents having formats suitable for personal digital assistants using a user personal computer as a server by one click of a mouse. The system for converting contents for PDAs has a browser for PDAs and a converter. The browser for PDAs is an application program obtained by integrating a DOC reader function, an image viewer function as well as an extended notepad function into one, and which is installed in a PDA for displaying various contents. The converter is installed in a user personal computer (PC) for controlling conversion of contents, such as documents (DOC), notes, images and addresses to be used in the browser for PDAs, and controlling HotSync linking.

Under the provisions of Section 119 of 35 U.S.C., Applicants hereby claim the benefit of the filing date of Republic of Korea Application No. PATENT-2002-0025620 filed May 9, 2002, which Application is hereby incorporated herein by reference.

### BACKGROUND OF THE INVENTION

1. Field of the Invention

The present invention relates generally to a system and method for converting contents for personal digital assistants, and more particularly to a system and method for converting contents for personal digital assistants, which can conveniently convert contents provided on File Explorer, application, and Internet Explorer, such as word files and image files as well as Web documents, into contents having formats suitable for personal digital assistants using a user personal computer as a server by one click of a mouse.

2. Description of the Prior Art

Generally, a personal digital assistant (PDA) is a kind of a portable computer. It is a portable personal information terminal, which enables a user to keep working while moving when the user stores document files written by a computer in a home or an office in the PDA, and enables the user to manage his personal information and schedule, like an electronic pocketbook.

Such a PDA was initially used for restricted purposes, such as computation, schedule management, etc. With the rapid development of information and communication technologies, the PDA has been spotlighted as a representative information and communication means of next generation personal computers (PCs).

That is, the PDA enables the user to directly input information written by hand to the PDA. Further, the PDA can utilize all functions of the mobile Internet, such as on-line stock trading, electronic commerce, etc., as well as information exchange through computers. Moreover, the PDA can be provided with various pieces of traffic information in combination with a mobile phone, and can also function as a facsimile. As described above, the functions of the PDA are growing more and more diversified.

The PDA performing the above functions is generally incapable of using original files of various documents or images executable by a desktop computer as they are, so there is required a process of converting the documents or images into data of formats suitable for the PDA. Further, in order to utilize the converted data in the PDA, a PDA user classifies contents according to categories and performs data synchronization.

The PDA user installs and uses several software tools in his PDA so as to extend the utilities of the PDA. In such a case, the conventional PDA is inconvenient in that a DOC reader for enabling documents including long sentences of a DOC format to be read must be installed in the PDA so as to read E-book documents, and an image viewer or a file viewer, which is a converter program used in the PC to enable image files to be viewed, must be installed in the PDA so as to view image files.

Further, the conventional PDA is disadvantageous in that an exclusive conversion tool suitable for each user's PDA must be used so as to store contents in the PDA, and the PDA user must classify contents according to categories and perform data synchronization, thus complicating a process of converting contents.

### SUMMARY OF THE INVENTION

Accordingly, the present invention has been made keeping in mind the above problems occurring in the prior art, and an object of the present invention is to provide a system and method for converting contents for personal digital assistants (PDAs), which can simplify a complicated contents converting process by enabling the process of converting contents into formats suitable for the PDA to be executed by only one click of a mouse, and remove inconvenience that several converter programs must be additionally installed.

In order to accomplish the above object, the present invention provides a system for converting contents for personal digital assistants (PDAs), comprising a browser for PDAs which is an application program obtained by integrating a DOC reader function, an image viewer function as well as an extended notepad function into one, and which is installed in a PDA for displaying various contents; and a converter installed in a user personal computer (PC) for controlling conversion of contents, such as documents (DOC), notes, images and addresses to be used in the browser for PDAs, and controlling HotSync linking.

Further, the present invention provides a method of converting contents for personal digital assistants (PDAs), comprising the step of selecting one of a) storing contents, such as document or image files, in a PDA by clicking a mouse on File Explorer; b) storing contents, such as documents or images copied to a clipboard, in the PDA; and c) storing a desired part of contents in the PDA by clicking the mouse on Internet Explorer.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a view showing an example in which contents are stored in a PDA on File Explorer;

FIG. 2a is a view showing an example in which text documents of FIG. 1 are stored in the PDA;

FIG. 2b is a view showing an example in which image documents of FIG. 1 are stored in the PDA;

FIG. 2c is a view showing an example in which Hypertext Markup Language (HTML) documents of FIG. 1 are stored in the PDA;

FIG. 2d is a view showing an example in which e-book documents of FIG. 1 are stored in the PDA;

FIG. 3 is a view showing an example in which contents are copied to a clipboard on application and stored in the PDA; and

FIG. 4 is a view showing an example in which contents are stored in the PDA on Internet Explorer.

### DESCRIPTION OF THE PREFERRED EMBODIMENTS

Hereinafter, embodiments of the present invention will be described in detail with reference to the attached drawings. A system for converting contents for PDAs in accordance with the present invention is comprised of a converter for PCs and a browser for PDAs.

The converter for PCs is installed in a user PC to provide a function of easily controlling linking of the PDA and the PC using data synchronization software, such as HotSync linking, as well as conversion of contents, such as documents (DOC), notes, images and addresses which will be used in the browser for PDAs. Especially, the converter for PCs performs an excellent contents conversion function in combination with Explorer, however, the principles of the present invention are equally applicable to virtually any type of PC browser software.

In this case, the converter for PCs is used for Windows, and executed under a PC environment which runs Windows 95/98/NT/2000 and Internet Explorer 4.0 and above, and has an installation file of less than 200K for Windows.

On the other hand, the browser for PDAs is installed in the PDA to display various contents for PDAs, and is an application program, in which a conventional notepad function is extended and succeeded, and a DOC reader function and an image viewer function are integrated into one.

In this case, the converter for PCs and the browser for PDAs are automatically installed in the user PC and the PDA, respectively, through simple installation processes.

A contents converting process carried out by the above-described contents converting system for PDAs is performed by a user selecting one of storing contents, such as documents or image files, in the PDA on File Explorer by clicking a mouse, storing contents, such as documents or images copied to clipboard on application, in the PDA, and storing a desired part of contents in the PDA on Internet Explorer by clicking a mouse.

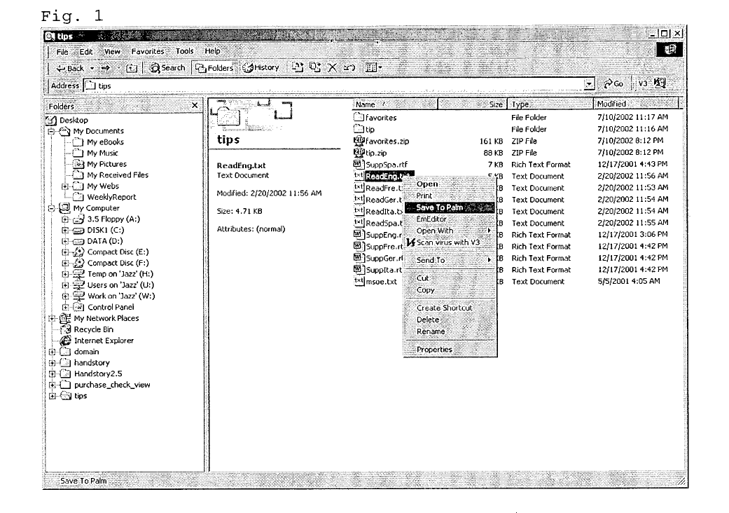

FIG. 1 is a view showing an example in which contents, such as documents or image files, are stored in the PDA on File Explorer by clicking a mouse. A user moves to a directory in which a desired file to be stored in the PDA exists on the File Explorer.

The user selects the desired file to be stored in the PDA in the moved directory and then clicks a right button of the mouse.

If the right button of the mouse is clicked, a pop-up window is executed as shown in FIG. 1, and desired contents, such as documents or image files, are stored in the PDA if the user selects a “Save To Palm” option in the pop-up window.

If the user selects the “Save To Palm” option, a corresponding one of four converter programs, that is, text, image, HTML and e-book converter programs, is run according to the kind of the selected file.

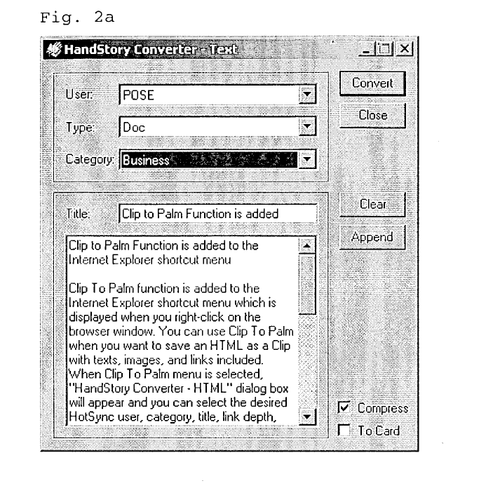

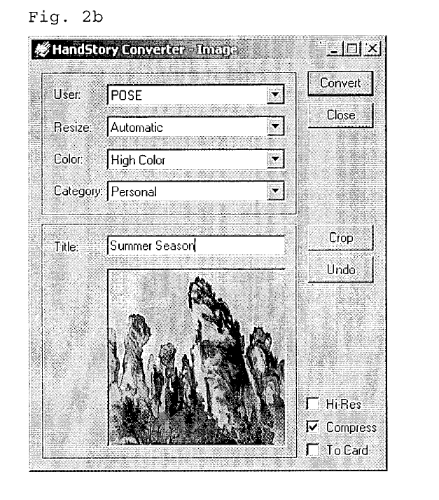

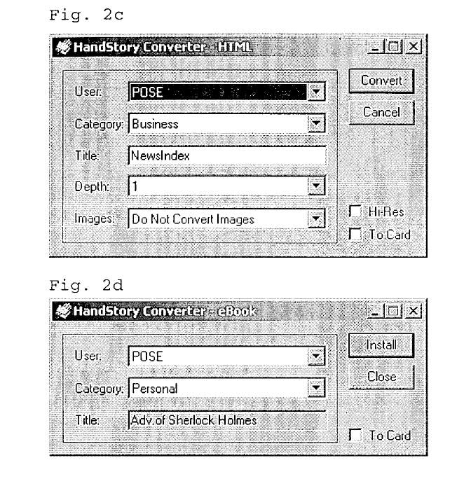

FIG. 2a is a view showing an example in which text documents of FIG. 1 are stored in the PDA, FIG. 2b is a view showing an example in which image documents of FIG. 1 are stored in the PDA, FIG. 2c is a view showing an example in which HTML documents of FIG. 1 are stored in the PDA, and FIG. 2d is a view showing an example in which e-book documents of FIG. 1 are stored in the PDA.

Referring to FIGS. 2a to 2d, the name of a PDA user who will transmit a current document at the time of next HotSync linking can be selected as ‘User’ shown in the drawings. Further, the type of a document required when a current document is converted into contents for PDAs can be selected among DOC, note and address book as ‘Type’ shown in the drawings. Further, the category of the document to be stored in the PDA can be selected as ‘Category’ shown in the drawings. Moreover, ‘Title’ for inputting the title of the current document is a title used in the PDA, and is also used as the name of a file to be converted.

After the inputting of the above-described various buttons are completed, the current document is converted into contents displayed through the browser for PDAs and stored in the PDA when the user presses a ‘Convert’ button. In this way, the converted document is stored as a document having a title inputted in the title window, and stored in the PDA at the time of next HotSync linking.

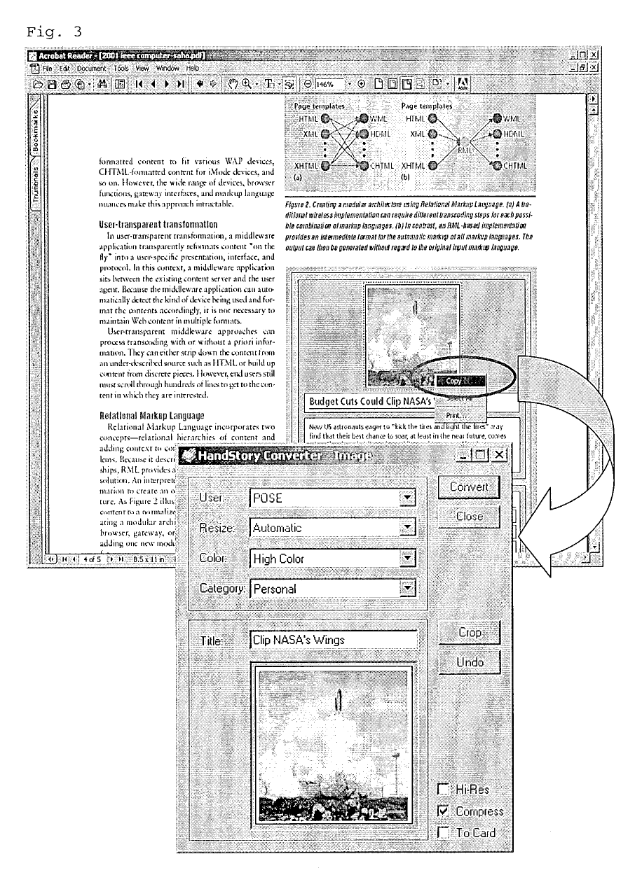

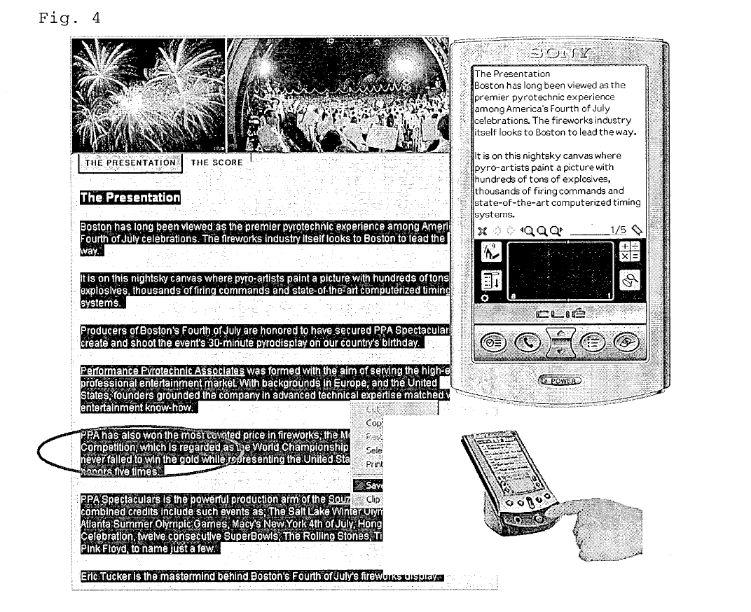

Meanwhile, FIG. 3 is a view showing an example in which contents, such as documents or images copied to a clipboard on application, are stored in the PDA. The user copies a desired part of contents to be stored in the PDA to the clipboard on application, as shown in FIG. 3.

Next, if a pop-up window is executed by running the converter, contents copied to the clipboard are pasted in the pop-up window. Thereafter, if a ‘Convert’ button is pressed, desired contents are stored in the PDA. Even in the case that contents, such as documents or images copied to the clipboard, are stored in the PDA, contents are stored in the PDA by pressing the ‘Convert’ button after the inputting of various buttons, such as ‘User’, ‘Category’ and ‘Title’, are completed.

FIG. 4 is a view showing an example in which a desired part of contents are stored in the PDA by clicking a mouse on Internet Explorer. The user performs block marking on contents on Internet Explorer, such as desired documents or images to be stored in the PDA, using a mouse, as shown in FIG. 4.

After the desired contents are block-marked, a right button of the mouse is clicked.

When the right button of the mouse is clicked, a pop-up window is executed as shown in FIG. 4. In this case, when the user selects a ‘Save To Palm’ option in the pop-up window, desired contents such as documents or images, which are block-marked, are stored in the PDA.

Therefore, the contents converting system for PDAs of the present invention enables the user to easily convert various contents such as documents or images provided on File Explorer, application and Internet Explorer into contents for PDAs by only one click of a mouse.

Although the preferred embodiments of a system and method for converting contents for PDAs of the present invention have been disclosed for illustrative purposes, those skilled in the art will appreciate that various modifications, additions and substitutions are possible, without departing from the scope and spirit of the invention as disclosed in the accompanying claims.

As described above, the present invention provides a system and method for converting contents for PDAs, which has the following advantages.

First, the present invention is advantageous in that it can simplify a complicated process of converting contents, and easily store desired data in the PDA through only one program, without additionally installing several programs including a converter.

Second, the present invention is advantageous in that it can enable a user to conveniently convert even word files as well as Web documents into files for PDAs by using a user PC as a server and by one click of a mouse, without a PDA exclusive Web site.

Third, the present invention is advantageous in that it provides contents having optimized file formats to correspond to PDAs in terms of a data synchronizing manner, thus obtaining high quality and low cost effects in providing Infrastructure, that is, hardware, networks, PDA functions, etc.

1. A system for converting contents from a user's personal computer (PC) for personal digital assistants (PDAs), wherein the PC includes data synchronization software, said system comprising:
a browser installed in a PDA for displaying contents wherein the contents are selected from the group consisting of documents (DOC), notes, images and addresses,
said browser comprising an application program operatively integrating a DOC reader function, an image viewer function as well as an extended notepad function; and
a converter installed in the (PC) for controlling conversion of the contents to be used in the browser for PDAs and for controlling linking of the PDA with the data synchronization software.

2. A method of converting selected contents from a user's personal computer (PC) having a display and a computer mouse for storage into personal digital assistants (PDAS) operatively communicating with the PC wherein the PC includes browser software and clipboard software, said method comprising the step of:
selecting, transmitting and storing contents from the PC to a PDA wherein said contents are selected from the group consisting of documents, document files, images and image files,
said step of storing contents including the step of selecting one of:
a) storing contents in a PDA by clicking the mouse on displayed icons generated in part by the browser software;
b) storing contents in the PDA that have been copied to the clipboard software; and
c) designating only a portion of said contents and then storing said portion in the PDA by clicking the mouse on the browser software.

3. The contents converting method for PDAs according to claim 2, wherein the browser software is File Explorer and the step a) includes the steps of:
moving to a directory on File Explorer in which a desired file to be stored in the PDA exists;
selecting the desired file to be stored in the PDA from the directory and clicking a button of the mouse; and
storing contents by selecting a “Save To Palm” option in a pop-up window executed by the clicking of the mouse.

4. The contents converting method for PDAs according to claim 2, wherein the step b) includes the steps of:
copying desired contents to be stored in the PDA to the clipboard on application; and
storing the contents copied to the clipboard after running a converter.

5. The contents converting method for PDAs according to claim 2, wherein the browser software is Internet Explorer and the step c) includes the steps of:
block-marking said portion of the contents on Internet Explorer to be stored in the PDA;
clicking a button of the mouse after block-marking said portion; and
storing said portion by selecting a “Save To Palm” option in a pop-up window executed by the clicking of the mouse.
